(19) United States
(12) Patent Application Publication
(10) Pub. No.: US 2025/0109056 A1
(43) Pub. Date: Apr. 3, 2025

(54) GLASS SUBSTRATE

(71) Applicant: AGC Inc., Tokyo (JP)

(72) Inventors: Shigeki SAWAMURA, Tokyo (JP); Naoki KANNO, Tokyo (JP)

(73) Assignee: AGC Inc., Tokyo (JP)

(21) Appl. No.: 18/979,248

(22) Filed: Dec. 12, 2024

Related U.S. Application Data
(63) Continuation of application No. PCT/JP2023/026793, filed on Jul. 21, 2023.

(30) Foreign Application Priority Data
Aug. 9, 2022 (JP) 2022-127385

(51) Int. Cl. C03C 3/068; C03C 3/062; C03C 3/064; C03C 3/066; C03C 3/19; C03C 3/21; G02B 27/01

(52) U.S. Cl. CPC C03C 3/068; C03C 3/062; C03C 3/064; C03C 3/066; C03C 3/19; C03C 3/21; G02B 27/0101

(57) ABSTRACT

A circular glass substrate including first and second main surfaces opposite each other, an edge portion between the first and second main surfaces, and a notch at a part of the edge portion. The glass substrate has a specific gravity of 3.00 or more; a radius r of 75 mm or more; a refractive index n_{d} of 1.800 or more; and a ratio (Tf/Tg) of a fictive temperature Tf (° C.) to a glass transition temperature Tg (° C.) of 1.00 or more. In a relationship of an internal transmittance to a wavelength, when converted for a thickness of 10 mm, a shortest wavelength λ₇₀ at which the internal transmittance becomes 70% is 440 nm or less; and a ratio (g/r) of deviation g (mm), of a center of mass (G) relative to a center (P), to the radius r, in a top view, is in a range of 0.05% to 1.2%.

### CROSS-REFERENCE TO RELATED APPLICATIONS

This application a continuation of International Application PCT/JP2023/026793, filed on Jul. 21, 2023 and designated the U.S., which is based on and claims priority to Japanese Patent Application No. 2022-127385 filed on Aug. 9, 2022, with the Japan Patent Office. The entire contents of all these applications are incorporated herein by reference.

### BACKGROUND OF THE INVENTION

### 1. Field of the Invention

The disclosure herein relates to glass substrates, and particularly to a glass substrate having a high refractive index and a high internal transmittance.

### 2. Description of the Related Art

AR glasses are attracting attention as a next-generation wearable display. There have also been proposals to use a glass substrate for the spectacle lens portion of AR glasses (see International Publication WO 2019/082616).

Such a glass substrate for AR glasses is required to have a high refractive index as a light guide member, as well as a high internal transmittance for visible light.

In general, it is known that a glass substrate having a high refractive index is inferior in strength to a glass substrate having a low refractive index, and breaks relatively easily even when a small stress is applied. Therefore, a glass substrate tends to become brittle as the specific gravity of the glass increases. This is because plastic deformation, which occurs when an object comes into contact with the glass substrate, is less likely to occur due to the higher density.

In particular, a notch is often formed at an edge portion of a glass substrate for AR glasses having a high refractive index, for the purpose of confirming the position when the glass substrate is handled during manufacturing of optical components and for adjusting the position of the wafer (alignment adjustment). However, such a notch tends to be a starting point of stress concentration, and for this reason, there is a problem that the glass substrate for AR glasses is easily damaged during the process flow and during handling of the glass substrate.

In view of such a situation, there is a demand for a glass substrate which is less likely to be damaged as a member for AR glasses.

The above problem is not limited to glass substrates for AR glasses. That is, the same problem can occur in any glass substrate having a high refractive index and internal transmittance along with stress concentration parts such as notches.

An object of the present disclosure is to provide a notched glass substrate that is more resistant to breakage.

### SUMMARY OF THE INVENTION

According to an embodiment, a glass substrate having a circular shape includes a first main surface and a second main surface opposite each other, an edge portion between the first main surface and the second main surface, and a notch at a part of the edge portion, wherein a specific gravity of the glass substrate is 3.00 or more; a radius r of the glass substrate is 75 mm or more; a refractive index n_{d} of the glass substrate is 1.800 or more; a ratio (Tf/Tg) of a fictive temperature Tf (° C.) of the glass substrate to a glass transition temperature Tg (° C.) of the glass substrate is 1.00 or more; in a relationship of an internal transmittance of the glass substrate to a wavelength, when converted for a thickness of 10 mm, with λ₇₀ being a shortest wavelength at which the internal transmittance becomes 70%, λ₇₀ is 440 nm or less; and a ratio (g/r) of a deviation g (mm), of a center of mass (G) of the glass substrate with respect to a center (P) of the glass substrate, to the radius r, in a top view, is in a range of 0.05% to 1.2%.

According to at least one embodiment, it is possible to provide a notched glass substrate that is more resistant to breakage.

### BRIEF DESCRIPTION OF THE DRAWINGS

FIG. 1 is a conceptual diagram schematically showing a relationship between wavelength and internal transmittance (a value converted for a thickness of 10 mm) in two types of transparent members.

FIG. 2 is a top view schematically showing an example of a glass substrate according to an embodiment of the present disclosure.

FIG. 3 is a side view schematically showing a configuration an edge portion of the glass substrate according to an embodiment of the present disclosure.

FIG. 4 is a side view schematically showing a configuration of a first chamfered surface at the edge portion of the glass substrate according to an embodiment of the present disclosure.

FIG. 5 is an enlarged view schematically showing a notch provided in the glass substrate according to an embodiment of the present disclosure.

### DESCRIPTION OF THE PREFERRED EMBODIMENTS

Embodiments of the present disclosure will now be described.

An embodiment of the present disclosure is a glass substrate having a circular shape, including a first main surface and a second main surface opposite each other, an edge portion between the first main surface and the second main surface, and a notch at a part of the edge portion, wherein a specific gravity of the glass substrate is 3.00 or more; a radius r of the glass substrate is 75 mm or more; a refractive index n_{d} of the glass substrate is 1.800 or more; a ratio (Tf/Tg) of a fictive temperature Tf (° C.) of the glass substrate to a glass transition temperature Tg (° C.) of the glass substrate is 1.00 or more; in a relationship of an internal transmittance of the glass substrate to a wavelength, when converted for a thickness of 10 mm, with λ₇₀ being a shortest wavelength at which the internal transmittance becomes 70%, λ₇₀ is 440 nm or less; and a ratio (g/r) of a deviation g (mm), of a center of mass (G) of the glass substrate with respect to a center (P) of the glass substrate, to the radius r, in a top view, is in a range of 0.05% to 1.2%.

The glass substrate according to an embodiment of the present disclosure has a refractive index n_{d} of 1.800 or more. The refractive index n_{d} may be, for example, 1.820 or more, 1.850 or more, 1.900 or more, 1.940 or more, 1.960 or more, or 2.000 or more.

In the present application, the refractive index n_{d} represents the refractive index at the d-line of helium (wavelength 587.6 nm).

The specific gravity of the first glass substrate is 3.00 or more, and as an example, is in a range of 3.10 to 6.50. The specific gravity of the first glass substrate is preferably in a range of 3.40 to 6.60, more preferably in a range of 3.50 to 6.40, still more preferably in a range of 3.60 to 6.30, still more preferably in a range of 4.00 to 6.22, and most preferably in a range of 4.30 to 6.15.

The glass substrate according to an embodiment of the present disclosure is characterized in that the wavelength λ₇₀ determined as described above is 440 nm or less.

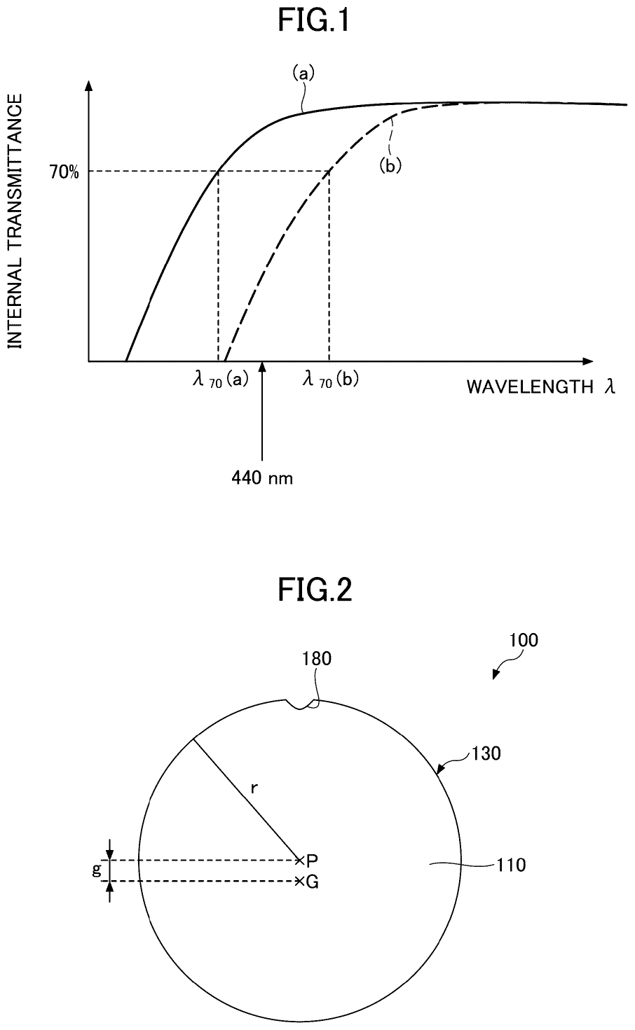

The characteristics will be described below with reference to FIG. 1.

FIG. 1 is a conceptual diagram schematically showing a relationship between wavelength and internal transmittance (a value converted for a thickness of 10 mm) in two types of transparent members (a and b). In FIG. 1, curve (a) is the internal transmittance profile of a first transparent member, and curve (b) is the internal transmittance profile of a second transparent member.

As shown by (b) in FIG. 1, the internal transmittance of the second transparent member for visible light, especially blue light, is not very high. On the other hand, as shown by (a) in FIG. 1, the first transparent member has a higher internal transmittance for blue light and a higher transmittance for all visible light, compared to the second transparent member.

Here, from FIG. 1, the wavelength at which the internal transmittance of the first transparent member becomes 70%, that is, λ₇₀(a), and the wavelength at which the internal transmittance of the second transparent member becomes 70%, that is, λ₇₀(b), are found to be λ₇₀(a)≤440 nm and λ₇₀(b)>440 nm.

From this, it is understood that the quality of the internal transmittance of the transparent member for visible light can be judged depending on whether λ₇₀≤440 nm is satisfied.

The glass substrate according to an embodiment of the present disclosure satisfies λ₇₀≤440 nm. Therefore, it can be said that the internal transmittance of the glass substrate for visible light is high.

From the features described above, the glass substrate according to an embodiment of the present disclosure can be used as a member for which a high refractive index n_{d} and a high internal transmittance for visible light are required, that is, as a glass substrate for AR glasses, for example.

Note that, as described above, the notched glass substrate for AR glass of the related art has a problem that stress tends to concentrate in the notch, and the notched glass substrate is prone to being damaged during a handling operation or the like.

In contrast to this, the glass substrate according to an embodiment of the present disclosure is further characterized in that:
(i) the ratio (Tf/Tg) of the fictive temperature Tf (° C.) to the glass transition temperature Tg (° C.) is 1.00 or more; and
(ii) the ratio (g/r) of the deviation g (mm), of the center of mass G of the glass substrate with respect to the center P of the glass substrate, to the radius r is in a range of 0.05% to 1.2%.

The fictive temperature Tf of the glass is an index indicating the temperature at which the glass structure achieves quasi-thermal equilibrium (a stable structure). Since the stable structure of the glass changes according to the rate of cooling from the molten state, the fictive temperature Tf of the obtained glass can be changed by changing the rate of cooling.

Relatively speaking, glass having a higher fictive temperature Tf tends to have a lower specific gravity and reduced brittleness.

Therefore, when the ratio (Tf/Tg) is set to 1.00 or more as in an embodiment of the present disclosure, the brittleness of the glass substrate can be improved.

Further, in the glass substrate according to an embodiment of the present disclosure, the ratio (g/r) of the deviation g (mm), of the center of mass G with respect to the center P, to the radius r is suppressed within a range of 0.05% to 1.2%.

Therefore, in an embodiment of the present disclosure, when the glass substrate is subjected to operations such as rotation and spinning, a biased centrifugal force is generated due to the deviation of the center of mass G from the center P, and the problem of damage to the glass substrate is significantly ameliorated.

According to the above effect, in an embodiment of the present disclosure, it is possible to provide a glass substrate which is resistant to damage in spite of having a high refractive index n_{d}. In addition, the glass substrate according to an embodiment of the present disclosure can be suitably applied to the spectacle lens portion of AR glasses.

### Glass Substrate According to an Embodiment of the Present Disclosure

Next, the structure and features of the glass substrate according to an embodiment of the present disclosure will be described in more detail, with reference to FIG. 2.

FIG. 2 schematically shows an example of a top view of a glass substrate according to an embodiment of the present disclosure.

As shown in FIG. 2, a glass substrate (hereinafter referred to as a “first glass substrate”) 100 according to an embodiment of the present disclosure has a substantially circular shape.

The first glass substrate 100 has a substantially circular first main surface 110 and a substantially circular second main surface 120 (not visible in FIG. 1) that are opposite each other, and an edge portion 130 between the first main surface 110 and the second main surface 120.

A notch 180 is formed in a part of the edge portion 130 of the first glass substrate 100.

The radius r of the first glass substrate 100 is 75 mm or more, and for example, is in a range of 75 mm to 160 mm. The radius r is preferably in a range of 85 mm to 135 mm, and more preferably in a range of 98 mm to 120 mm.

The first glass substrate 100 has a refractive index n_{d} of 1.800 or more. The specific gravity of the first glass substrate 100 is 3.00 or more.

As described above, the first glass substrate 100 has a feature that, in the relationship between the internal transmittance and the wavelength, when converted for a thickness of 10 mm, the shortest wavelength λ₇₀ at which the internal transmittance becomes 70% is 440 nm or less. Therefore, the first glass substrate 100 has a high internal transmittance for visible light.

As shown in FIG. 2, the first glass substrate 100 has a center P and a center of mass G. The distance between the center P and the center of mass G (also referred to as the “deviation g”) is selected so that the value of (deviation g/radius r) is in a range of 0.05% to 1.2%. Preferably, g/r is in a range of 0.1% to 1.0%.

Further, in the first glass substrate 100, the ratio (Tf/Tg) of the fictive temperature Tf (° C.) to the glass transition temperature Tg (° C.) is 1.00 or more. Therefore, the brittleness of the first glass substrate 100 is significantly reduced.

The fictive temperature Tf (° C.) of the glass substrate can be adjusted by controlling the cooling rate in the processing occurring from when the glass is in a molten state to when the glass has solidified.

In particular, the ratio (Tf/Tg) is preferably 1.02 or more, more preferably 1.03 or more, still more preferably 1.04 or more, and most preferably 1.05 or more.

The first glass substrate 100 having such features can be suitably applied as a glass substrate for AR glasses, for which a high refractive index n_{d} and a high internal transmittance to visible light are required.

### Other Features of a Glass Substrate According to an Embodiment of the Present Disclosure

Next, other features glass substrate according to an embodiment of the present disclosure will be described.

For the sake of clarity, the above-described first glass substrate 100 will be assumed to be the glass substrate according to an embodiment of the present disclosure, and its features will be described. Accordingly, the reference numerals shown in FIG. 2 will be used to denote each portion.

### Composition

The composition of the first glass substrate 100 is not particularly limited.

The first glass substrate 100 may be, for example, silica-based glass, phosphoric acid-based glass, boric acid-based glass, or tellurite-based glass. The silica-based glass preferably contains, for example, 20 mol % or more of SiO₂. The phosphoric acid-based glass preferably contains, for example, 20 mol % or more of P₂O₅. The boric acid-based glass preferably contains, for example, 10 mol % or more of B₂O₃. The tellurite-based glass preferably contains, for example, 10 mol % or more of TeO₂.

The first glass substrate 100 may be, for example, silica-based glass, phosphoric acid-based glass, boric acid-based glass, or tellurite-based glass.

The first glass substrate 100 may include, as a high refractive index component, at least one selected from a group consisting of TiO₂, Nb₂O₅, Bi₂O₃, La₂O₃, and Gd₂O₃.

The total amount of TiO₂, Nb₂O₅, Bi₂O₃, La₂O₃, and Gd₂O₃ is, for example, in a range of 1 mol % to 80 mol %. This total amount is preferably in a range of 5 mol % to 75 mol %, more preferably in a range of 10 mol % to 70 mol %, and more preferably in a range of 15 mol % to 65 mol % from the viewpoint of a high refractive index, strength characteristics, and manufacturing characteristics.

The total amount of iron, chromium, and nickel in the first glass substrate 100 is preferably less than 8 ppm by mass, more preferably less than 6 ppm by mass, and even more preferably less than 4 ppm by mass.

By setting the total amount of iron, chromium, and nickel, which are colored transition metals, to less than 8 ppm by mass, a decrease in the internal transmittance of visible light in the first glass substrate 100 can be significantly suppressed.

Also, from the viewpoint of environmental load, the first glass substrate 100 is preferably substantially free of arsenic, lead, and antimony.

### Edge Portion Shape

The first glass substrate 100 has an edge portion 130 in which a notch 180 is formed.

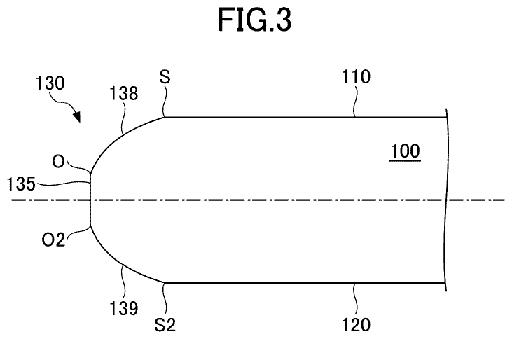

FIG. 3 schematically shows an example of a configuration of a side surface of the edge portion 130 of the first glass substrate 100.

As shown in FIG. 3, the edge portion 130 has a side surface region 135, a first chamfered surface 138, and a second chamfered surface 139.

In the present application, the “side surface region” means the entire part of the edge portion 130 closer to the outer edge than the first chamfered surface 138 and the second chamfered surface 139.

The edge portion 130 preferably has the following configuration.

The side surface region 135 and the first chamfered surface 138 have a boundary O. In other words, the first chamfered surface 138 is joined to the side surface region 135 at the boundary O. Furthermore, the first chamfered surface 138 and the first main surface 110 have a boundary S. In other words, the first chamfered surface 138 is joined to the first main surface 110 at the boundary S.

Similarly, the second chamfered surface 139 is joined to the side surface region 135 at a boundary O2. The second chamfered surface 139 is joined to the second main surface 120 at a boundary S2.

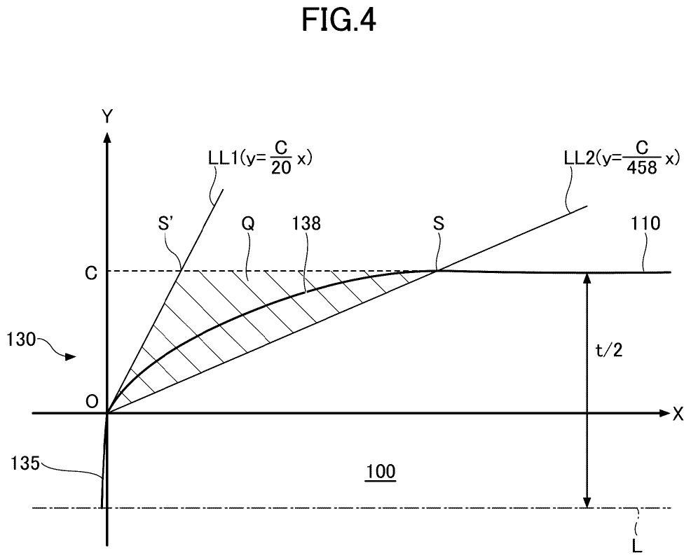

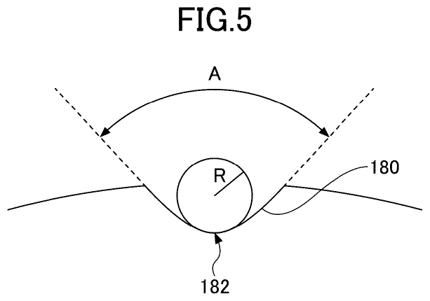

FIG. 4 is an enlarged view of the first chamfered surface 138.

FIG. 4 schematically shows the shape of the first glass substrate 100, in a side view, above a bisector L drawn passing through the center of the thickness t of the first glass substrate 100.

As shown in FIG. 4, in a top view, a direction along the first main surface 110 of the first glass substrate and 100 extending perpendicularly to the edge portion 130 of the first glass substrate 100 is defined as the X axis. A thickness direction of the first glass substrate 100 is defined as the Y axis. Further, the boundary O between the first chamfered surface 138 and the side surface region 135 is defined as the origin o of the X axis and the Y axis.

The Y-axis value of the boundary S (also referred to as “intersection S”) between the first chamfered surface 138 and the first main surface 110 is C (μm).

In this case, the edge portion 130 of the first glass substrate 100 is configured such that C satisfies (t/5)≤C≤(t/3).

The first chamfered surface 138 is preferably configured to be included in a region Q.

Here, the region Q represents a region surrounded by a straight line LL1 connecting the origin O and an intersection S′, a line of y=C, and a straight line LL2 connecting the origin O and the intersection S.

Note that the straight line LL1 is represented by

$$y = ( C / 20 ) \cdot x , \qquad Expression ( 1 )$$

and the straight line LL2 is represented by

$$y = ( C / 458 ) \cdot x . \qquad Expression ( 2 )$$

The intersection S′ is the intersection of the straight line LL1 and the line of y=C, and its coordinates are represented by (X1, C). The intersection S is the intersection of the straight line LL2 and the line of y=C, and its coordinates are represented by (X2, C). Here, 5<X1<50 and 350<X2<500.

Preferably, the first chamfered surface 138 is configured to have a profile in which the Y-axis value increases monotonically in the region Q, from the origin O toward the intersection S.

When the first chamfered surface 138 is configured in this manner, stress concentration on the edge portion 130 can be significantly reduced during the handling operation of the first glass substrate 100. Therefore, the possibility of the first glass substrate breaking starting from a portion other than the notch 180 can be significantly reduced.

A preferred shape of the first chamfered surface 138 has been described above. However, separately from or in addition to this, the second chamfered surface 139 may have such a shape.

In this case, in a top view, a direction along the second main surface 120 of the first glass substrate 100 and extending perpendicularly to the target edge portion 130 of the first glass substrate 100 is defined as the X axis. The thickness direction of the first glass substrate 100 is defined as the Y axis. Further, the boundary O2 between the second chamfered surface 139 and the side surface region 135 is defined as the origin of the X axis and the Y axis.

With the Y-axis value of an intersection S2 between the second chamfered surface 139 and the second main surface 120 being C2 (μm), the second chamfered surface 139 is configured such that C2 satisfies (t/5)≤C2≤(t/3).

The second chamfered surface 139 is preferably configured to be included in a region Q2.

Here, the region Q2 represents a region surrounded by a straight line LR1 connecting the origin O2 and an intersection S2′, a line of y=C2, and a straight line LR2 connecting the origin O2 and the intersection S2.

Note that the straight line LR1 is represented by

$$y = ( C 2 / 20 ) \cdot x , \qquad Expression ( 3 )$$

and the straight line LR2 is represented by

$$y = ( C 2 / 458 ) \cdot x . \qquad Expression ( 4 )$$

The intersection S2′ is the intersection of the straight line LR1 and the line of y=C2, and its coordinates are represented by (X3, C2). The intersection S2 is the intersection of the straight line LR2 and the line of y=C2, and its coordinates are represented by (X4, C2). Here, 5<X3<50 and 350<X4<500.

The second chamfered surface 139 is configured to have a profile in which the Y-axis value monotonically increases in the region Q2, from the origin O2 toward the intersection S2.

When the second chamfered surface 139 is configured in this manner as well, it is possible to significantly reduce the possibility of the first glass substrate breaking starting at a point other than the notch 180.

### Notch 180

The first glass substrate 100 includes the notch 180.

FIG. 5 shows a schematic enlarged view of the notch 180.

As shown in FIG. 5, the notch 180 has a notch tip 182. The radius of the notch tip 182 (hereinafter referred to as “notch tip radius R”) is, for example, in a range of 0.7 mm to 3.0 mm.

The notch 180 has an opening angle A. For example, the opening angle A is in a range of 60° to 120°, may be in a range of 70° to 110°, is preferably in a range of 75° to 105°, is more preferably in a range of 80° to 100°, and is most preferably in a range of 85° to 98°.

### Other Characteristics

The first glass substrate 100 may have a specific modulus in a range of 8 MNm/kg to 35 MNm/kg, preferably in a range of 10 MNm/kg to 30 MNm/kg, and more preferably in a range of 11 MNm/kg to 28 MNm/kg.

The thickness t of the first glass substrate 100 may be in a range of 0.1 mm to 1.0 mm.

The first main surface 110 and/or the second main surface 120 of the first glass substrate 100 may have a surface roughness (arithmetic mean roughness Ra) of 10 nm or less.

The first glass substrate 100 may have a total thickness variation (TTV) of 10 μm or less. The TTV represents the difference between the maximum height and the minimum height from the back surface of the sample, as measured when the back surface of the sample is adsorbed to a flat chuck surface.

The first glass substrate 100 may have a bow (height of the substrate center surface) of 100 μm or less, preferably 50 μm or less. The bow represents the height of the center surface of the sample in a free state (unclamped state) with respect to a reference plane. The reference plane has a center point in a region to which a standard is applied, and the bow is measured as the distance of the center surface of the sample from this center point in the reference plane.

The first glass substrate 100 has a warp, determined from the root mean square plane, of 100 μm or less, preferably 80 μm or less, more preferably 50 μm or less, still more preferably 40 μm or less, and most preferably 30 μm or less.

### EXAMPLES

Examples of the present disclosure will be described below. In the following description, Examples 1 to 15 are examples, and Examples 21 to 23 are comparative examples.

### Example 1

A glass substrate was produced by the following method.

Glass raw material, weighed to obtain the desired glass composition, was put in a melting furnace and a glass melt was obtained. The obtained glass melt was stirred and homogenized.

Next, the glass melt was formed in a mold to obtain the desired glass block. A stainless steel mold was used as the mold. Then, the formed glass was conveyed by roller and slowly cooled in a slow cooling furnace. In the slow cooling furnace, the slow cooling rate is controlled by adjusting the slow cooling temperature and the conveying speed, to prevent the glass sheet from cracking. The fictive temperature Tf of the glass is determined by the slow cooling condition.

The obtained glass block, after undergoing external processing, was cut into a disc shape and sliced. After slicing, lapping was performed to a predetermined thickness, and the edge surface of the cut disc-shaped glass plate was subjected to edge surface processing using CNC (Computerized Numerical Control) with a grinding diamond wheel grindstone. Thereafter, the diamond wheel grindstone was switched to a notch wheel grindstone, and the portion corresponding to the notch was machined to form a notch.

Then, the main surface of the glass was polished to obtain a glass substrate having a diameter of 150 mm. The thickness of the glass substrate was 0.5 mm.

The glass substrate thus produced is hereinafter referred to as “glass substrate 1”.

### Examples 2 to 15

Glass substrates were produced by the same method as in Example 1.

However, in Examples 2 to 15, the glass substrates were produced while changing the raw material compositions, cooling conditions, and the like from those in Example 1.

The produced glass substrates are hereinafter referred to as “glass substrate 2” to “glass substrate 15”, respectively.

### Example 21

A glass substrate was produced by the same method as in Example 1.

However, in Example 21, the glass substrate was produced while changing the raw material composition, cooling conditions, and the like from those in Example 1.

The glass substrate thus produced is hereinafter referred to as “glass substrate 21”.

### Examples 22 and 23

Glass substrates were produced by the same method as Example 21.

However, in Examples 22 and 23, the glass substrates were produced while changing the raw material compositions, cooling conditions, and the like from those in Example 21.

The produced glass substrates are referred to as “glass substrate 22” and “glass substrate 23”, respectively.

Table 1 below shows the composition of each glass substrate.

TABLE 1

| COMPOSITION | GLASS SUBSTRATE | | | | | | | | | | | | | | | | | |
|---|---|---|---|---|---|---|---|---|---|---|---|---|---|---|---|---|---|---|
| (mol %) | 1 | 2 | 3 | 4 | 5 | 6 | 7 | 8 | 9 | 10 | 11 | 12 | 13 | 14 | 15 | 21 | 22 | 23 |
| SiO₂ | 12.2 | 0.8 | 15.0 | 13.8 | 29.0 | — | 15.1 | 11.8 | — | 8.9 | 12.0 | 11.0 | 0.5 | 0.5 | 1.8 | — | 10.5 | 0.6 |
| B₂O₃ | 19.8 | — | 25.0 | 20.6 | 9.0 | 21.5 | 24.0 | 20.3 | 27.4 | 23.6 | 22.0 | 16.0 | — | 3.0 | 22.4 | 21.5 | 16.5 | — |
| P₂O₅ | — | 26.5 | — | — | — | 9.6 | — | — | 8.0 | — | — | — | 23.0 | 25.4 | 6.2 | 9.6 | — | 23.0 |
| TeO₂ | — | — | — | — | — | 26.5 | — | — | 18.5 | — | — | — | — | — | 25.0 | 26.4 | — | — |
| Li₂O | 0.5 | 0.3 | — | — | 2.0 | — | — | — | — | — | — | — | — | — | — | — | — | — |
| Na₂O | — | 0.3 | — | — | — | — | — | — | — | — | — | — | 2.0 | 9.0 | — | — | — | 2.0 |
| K₂O | — | 5.2 | — | — | — | — | — | — | — | — | — | — | 1.0 | 6.0 | — | — | — | 1.0 |
| CaO | — | — | 11.4 | — | 6.4 | — | — | — | — | — | — | — | 0.2 | 0.2 | — | — | — | 0.2 |
| SrO | — | — | 7.8 | — | 7.6 | — | — | — | — | — | — | — | — | — | — | — | — | — |
| BaO | — | — | 7.9 | 0.5 | 8.8 | — | — | — | — | — | — | — | 6.0 | 1.0 | — | — | — | 6.0 |
| ZnO | — | — | — | — | — | 5.4 | — | — | — | — | 2.5 | 2.0 | — | — | 5.3 | 5.4 | 2.0 | — |
| La₂O₃ | 26.4 | — | 5.1 | 26.4 | 6.8 | — | 22.7 | 18.4 | — | 19.0 | 24.0 | 22.0 | — | — | — | — | 22.0 | — |
| Y₂O₃ | 3.0 | — | — | 0.3 | — | — | 4.0 | 3.4 | — | 4.0 | 0.5 | 0.5 | — | — | — | — | 0.5 | — |
| Gd₂O₃ | — | — | — | 2.5 | — | — | — | 3.4 | — | 3.9 | 3.0 | 5.0 | — | — | — | — | 5.0 | — |
| Bi₂O₃ | — | — | — | — | — | 30.4 | — | — | 43.4 | — | — | — | 18.5 | — | 33.4 | 30.4 | — | 18.5 |
| ZrO₂ | 7.2 | — | 4.2 | 7.0 | 3.2 | — | 6.0 | 6.9 | — | 6.5 | 7.0 | 8.5 | — | — | 2.6 | — | 8.5 | — |
| TiO₂ | 25.1 | 43.1 | 20.9 | 22.8 | 20.9 | — | 24.0 | 33.2 | 0.9 | 30.5 | 25.0 | 30.0 | 14.6 | 25.5 | — | — | 30.0 | 14.5 |
| Nb₂O₅ | 5.2 | 17.5 | 2.7 | 6.1 | 6.3 | 6.7 | 4.0 | 2.6 | 0.9 | 3.3 | 4.0 | 5.0 | 17.0 | 29.4 | 3.3 | 6.7 | 5.0 | 17.0 |
| Ta₂O₅ | — | — | — | — | — | — | — | — | 0.9 | — | — | — | — | — | — | — | — | — |
| WO₃ | 0.6 | 6.3 | — | — | — | — | 0.2 | — | — | 0.3 | — | — | 17.2 | — | — | — | — | 17.2 |
| TiO₂ + Nb₂O₅ + | 56.2 | 61.2 | 28.7 | 58.1 | 34.0 | 37.1 | 50.7 | 57.6 | 44.6 | 56.7 | 56.0 | 62.0 | 50.0 | 54.9 | 35.6 | 37.1 | 62.0 | 50.0 |
| Bi₂O₃ + La₂O₃ + | | | | | | | | | | | | | | | | | | |
| Gd₂O₃ | | | | | | | | | | | | | | | | | | |

### Evaluation

Various characteristics were evaluated using each glass substrate.

The evaluation results obtained for each glass substrate are shown in Table 2.

TABLE 2

| | GLASS SUBSTRATE | | | | | | | | | |
|---|---|---|---|---|---|---|---|---|---|---|
| | 1 | 2 | 3 | 4 | 5 | 6 | 7 | 8 | 9 | 10 |
| THICKNESS (mm) | 0.30 | 0.30 | 0.35 | 0.30 | 0.30 | 0.40 | 0.30 | 0.30 | 0.30 | 0.30 |
| REFRACTIVE | 2.000 | 1.985 | 1.851 | 2.000 | 1.902 | 2.101 | 1.963 | 2.010 | 2.128 | 2.001 |
| INDEX n_{d} | | | | | | | | | | |
| SPECIFIC | 5.02 | 3.54 | 3.95 | 4.90 | 4.26 | 6.19 | 4.81 | 4.94 | 6.77 | 4.98 |
| GRAVITY (g/cm³) | | | | | | | | | | |
| GLASS TRANSITION | 725 | 658 | 647 | 721 | 676 | 428 | 676 | 705 | 416 | 721 |
| TEMPERATURE Tg (° C.) | | | | | | | | | | |
| FICTIVE | 747 | 684 | 679 | 757 | 744 | 441 | 744 | 726 | 441 | 750 |
| TEMPERATURE Tf (° C.) | | | | | | | | | | |
| Tf/Tg | 1.03 | 1.04 | 1.05 | 1.05 | 1.1 | 1.03 | 1.1 | 1.03 | 1.06 | 1.04 |
| λ₇₀ (nm) | 409 | 403 | 380 | 392 | 390 | 420 | 400 | 420 | 425 | 410 |
| DEVIATION g/ | ∘ | ∘ | ∘ | ∘ | ∘ | ∘ | ∘ | ∘ | ∘ | ∘ |
| RADIUS r | | | | | | | | | | |
| FIRST CHAMFERED | ∘ | ∘ | ∘ | ∘ | ∘ | ∘ | ∘ | ∘ | ∘ | ∘ |
| SURFACE SHAPE | | | | | | | | | | |
| SECOND CHAMFERED | ∘ | ∘ | ∘ | ∘ | ∘ | ∘ | ∘ | ∘ | ∘ | ∘ |
| SURFACE SHAPE | | | | | | | | | | |
| NOTCH OPENING | 90 | 85 | 90 | 98 | 80 | 90 | 70 | 90 | 105 | 90 |
| ANGLE A (°) | | | | | | | | | | |
| NOTCH TIP | 0.85 | 1.20 | 1.00 | 1.35 | 1.40 | 2.00 | 1.00 | 1.00 | 85.00 | 2.00 |
| RADIUS R (mm) | | | | | | | | | | |
| SPECIFIC MODULUS | 26.1 | 28.5 | 28.4 | 28.2 | 27.5 | 11.3 | 27.8 | 27.4 | 10.2 | 27.1 |
| (GPa · cm³/g) | | | | | | | | | | |
| SURFACE | 4 | 6 | 5 | 5 | 5 | 7 | 6 | 5 | 6 | 5 |
| ROUGHNESS Ra (nm) | | | | | | | | | | |
| TTV (μm) | 4 | 4 | 7 | 5 | 4 | 8 | 6 | 6 | 5 | 6 |
| BOW (μm) | 42 | 46 | 30 | 71 | 35 | 38 | 25 | 25 | 59 | 20 |
| WARP (μm) | 39 | 50 | 21 | 75 | 25 | 41 | 20 | 19 | 55 | 20 |
| YOUNG'S | 131 | 101 | 112 | 138 | 117 | 70 | 134 | 135 | 69 | 135 |
| MODULUS E (GPa) | | | | | | | | | | |
| HANDLING | ∘ | ∘ | ∘ | ∘ | ∘ | ∘ | ∘ | ∘ | ∘ | ∘ |
| OPERABILITY | | | | | | | | | | |

| | GLASS SUBSTRATE | | | | | | | |
|---|---|---|---|---|---|---|---|---|
| | 11 | 12 | 13 | 14 | 15 | 21 | 22 | 23 |
| THICKNESS (mm) | 0.50 | 0.30 | 0.40 | 0.30 | 0.30 | 0.30 | 0.30 | 0.40 |
| REFRACTIVE | 2.001 | 2.051 | 2.104 | 1.946 | 2.114 | 2.102 | 2.055 | 2.107 |
| INDEX n_{d} | | | | | | | | |
| SPECIFIC | 5.12 | 5.27 | 5.63 | 3.51 | 6.40 | 6.19 | 5.27 | 5.63 |
| GRAVITY (g/cm³) | | | | | | | | |
| GLASS TRANSITION | 709 | 743 | 561 | 637 | 430 | 428 | 743 | 561 |
| TEMPERATURE Tg (° C.) | | | | | | | | |
| FICTIVE | 744 | 758 | 600 | 701 | 456 | 394 | 698 | 527 |
| TEMPERATURE Tf (° C.) | | | | | | | | |
| Tf/Tg | 1.05 | 1.02 | 1.07 | 1.1 | 1.06 | 0.92 | 0.94 | 0.94 |
| λ₇₀ (nm) | 390 | 410 | 430 | 420 | 394 | 420 | 410 | 430 |
| DEVIATION g/ | ∘ | ∘ | ∘ | ∘ | ∘ | x | ∘ | ∘ |
| RADIUS r | | | | | | | | |
| FIRST CHAMFERED | ∘ | ∘ | ∘ | ∘ | ∘ | x | x | ∘ |
| SURFACE SHAPE | | | | | | | | |
| SECOND CHAMFERED | ∘ | ∘ | ∘ | ∘ | ∘ | x | x | ∘ |
| SURFACE SHAPE | | | | | | | | |
| NOTCH OPENING | 90 | 100 | 110 | 90 | 75 | 90 | 90 | 50 |
| ANGLE A (°) | | | | | | | | |
| NOTCH TIP | 0.80 | 1.00 | 2.50 | 1.00 | 1.00 | 1.00 | 1.00 | 0.50 |
| RADIUS R (mm) | | | | | | | | |
| SPECIFIC MODULUS | 25.4 | 25.8 | 15.6 | 29.3 | 10.5 | 11 | 26 | 16 |
| (GPa · cm³/g) | | | | | | | | |
| SURFACE | 5 | 5 | 4 | 4 | 5 | 8 | 7 | 6 |
| ROUGHNESS Ra (nm) | | | | | | | | |
| TTV (μm) | 4 | 6 | 5 | 5 | 6 | 7 | 6 | 5 |
| BOW (μm) | 21 | 30 | 67 | 30 | 74 | 20 | 28 | 37 |
| WARP (μm) | 30 | 27 | 62 | 28 | 80 | 25 | 40 | 20 |
| YOUNG'S | 130 | 136 | 88 | 103 | 67 | 70 | 136 | 88 |
| MODULUS E (GPa) | | | | | | | | |
| HANDLING | ∘ | ∘ | ∘ | ∘ | ∘ | x | x | x |
| OPERABILITY | | | | | | | | |

Table 2 shows “refractive index n_{d}”, “specific gravity”, “glass transition temperature Tg”, “fictive temperature Tf”, “Tf/Tg”, “λ₇₀”, “deviation g/radius r”, “first chamfered surface shape”, “second chamfered surface shape”, “notch opening angle A”, “notch tip radius R”, “specific modulus”, “surface roughness Ra”, “TTV”, “bow”, “warp”, “Young's modulus E”, and “handling operability” of each glass substrate.

The “refractive index n_{d}” of each glass substrate was measured by the V-block method using KPR-4000.

The “fictive temperature Tf” was calculated as follows.

First, the aforementioned glass substrate (for example, glass substrate 1) was cut to a size of 20 mm×20 mm×1 mm to prepare a piece of glass. Next, the piece of glass was heated to a predetermined heat treatment temperature in a reducing atmosphere, held in this state for two hours, and then rapidly cooled to room temperature.

This heat treatment was carried out at different heat treatment temperatures to prepare four pieces of glass (evaluation samples) with different thermal histories.

The refractive index n_{d} of each evaluation sample was measured. Further, a relational expression between the heat treatment temperature and the refractive index n_{d} was obtained from the four evaluation samples. Using the obtained relational expression, a corresponding heat treatment temperature was obtained from the refractive index n_{d} measured for the glass substrate 1, and this was set as the fictive temperature Tf.

The fictive temperature Tf was also obtained for the other glass substrates by the same method.

“λ₇₀” was evaluated using a spectrophotometer (U-4100 manufactured by Hitachi High-Tech Corporation).

The “deviation g/radius r” was calculated by taking the distance between the center P and the center of mass G of the glass substrate as the deviation g, and dividing the deviation g by the radius r of the glass substrate.

Furthermore, the “deviation g/radius r” was judged on a pass/fail (o/x) basis. That is, when the value of “deviation g/radius r” falls within 0.05% to 1.2%, it is judged as “o” (pass), and when it does not, it is judged as “x” (fail).

Also, the “first chamfered surface shape” and the “second chamfered surface shape” were judged on a pass/fail (o/x) basis. That is, when the shape of the first chamfered surface is included within the region Q defined as described above and has a profile that increases monotonically from the origin O to the intersection S, it is judged as “o”, and when it does not, it is judged as “x”. The same applies to the “second chamfered surface shape”.

The “specific modulus” of each glass substrate was calculated by dividing the Young's modulus evaluated using the ultrasonic pulse method by the specific gravity (density) obtained by the Archimedes method.

The “surface roughness Ra” represents the arithmetic mean roughness Ra measured on a first surface of each glass substrate. The “surface roughness Ra” is defined in JIS B0601 (2001). In the present application, measurements were made in an area of 10 μmx10 μm on a glass substrate using an atomic force microscope (AFM).

“TTV” means the difference between the maximum thickness and the minimum thickness in the entire area of the glass substrate. “TTV” was measured using a laser displacement meter or an optical interferometer.

The “bow” means the height of the center of the glass substrate from the reference plane. The “bow” was measured using an optical interferometer.

The “warp” of the glass substrate was measured using a laser displacement meter or an optical interferometer.

The “Young's modulus” of the glass substrate was measured using the ultrasonic pulse method.

The “handling operability” of the glass substrate was judged on a pass/fail (o/x) basis. In other words, when a crack or breakage occurred during the handling and process flow of the glass substrate, it was judged as “x”, and when the glass substrate was in a sound condition, it was judged as “o”.

From the evaluation results, it can be seen that the glass substrates 1 to 15 satisfied all of the characteristics (1) to (5) below.
(1) a specific gravity of 3.00 or more;
(2) a refractive index n_{d} of 1.800 or more;
(3) a ratio Tf/Tg of 1.00 or more;
(4) λ₇₀ of 440 nm or less;
(5) a ratio g/r in a range of 0.05% to 1.2%.

On the other hand, it can be seen that each of the glass substrates 21 to 23 does not satisfy at least one of (1) to (5) above.

In the glass substrates 21 to 23, cracks occurred in the glass substrates during the handling operation, but no such damage occurred in the glass substrates 1 to 15 even after the handling operation.

From the above results, it has been confirmed that cracks and breakage do not appreciably occur in the glass substrates 1 to 15 during the handling operation, in spite of these glass substrates 1 to 15 having a high refractive index and high internal transmittance.

### ASPECTS OF THE PRESENT DISCLOSURE

The present disclosure can have the following aspects.

### Aspect 1

A glass substrate having a circular shape, comprising a first main surface and a second main surface opposite each other, an edge portion between the first main surface and the second main surface, and a notch at a part of the edge portion, wherein
a specific gravity of the glass substrate is 3.00 or more;
a radius r of the glass substrate is 75 mm or more;
a refractive index n_{d} of the glass substrate is 1.800 or more;
a ratio (Tf/Tg) of a fictive temperature Tf (° C.) of the glass substrate to a glass transition temperature Tg (° C.) of the glass substrate is 1.00 or more;
in a relationship of an internal transmittance of the glass substrate to a wavelength, when converted for a thickness of 10 mm, with λ₇₀ being a shortest wavelength at which the internal transmittance becomes 70%, λ₇₀ is 440 nm or less; and
a ratio (g/r) of a deviation g (mm), of a center of mass (G) of the glass substrate with respect to a center (P) of the glass substrate, to the radius r, in a top view, is in a range of 0.05% to 1.2%.

### Aspect 2

The glass substrate according to Aspect 1, wherein
in a side view of the glass substrate, when a bisector passing through a center of a thickness t of the glass substrate is drawn, the edge portion has, above the bisector, a profile including a side surface region and a first chamfered surface,
in a top view of the glass substrate, when a direction along the first main surface and extending perpendicularly to the edge portion of the glass substrate is defined as an X axis, a thickness direction of the glass substrate is defined as a Y axis, a boundary between the side surface region and the first chamfered surface is defined as an origin O of the X axis and the Y axis, a boundary between the first chamfered surface and the first main surface is defined as an intersection S, and a Y-axis value of the intersection S is defined as C (μm), (t/5)≤C≤(t/3),
the first chamfered surface is included in a region Q surrounded by a first straight line connecting the origin 0 and an intersection S′, a line of y=C, and a second straight line connecting the origin O and the intersection S,
the first straight line is represented by Expression (1),
Expression (1) is: y=(C/20)·x,
the second straight line is represented by Expression (2),
Expression (2) is: y=(C/458)·x,
the intersection S′ is an intersection of the first straight line and the line of y=C, and coordinates of the intersection S′ are represented by (X1, C), where 5<X1<50,
the intersection S is intersection of the second straight line and the line of y=C, and coordinates of the intersection S are represented by (X2, C), where 350<X2<500, and
the first chamfered surface has a profile in which the Y-axis value increases monotonically from the origin o toward the intersection S, within the region Q.

### Aspect 3

The glass substrate according to Aspect 1 or 2, wherein the notch has an opening angle A in a range of 60° to 120°, and a tip radius R in a range of 0.7 mm to 3.0 mm.

### Aspect 4

The glass substrate according to any one of Aspects 1 to 3, wherein the glass substrate includes at least one selected from a group consisting of TiO₂, Nb₂O₅, Bi₂O₃, La₂O₃, and Gd₂O₃.

### Aspect 5

The glass substrate according to Aspect 4, wherein a total amount of TiO₂, Nb₂O₅, Bi₂O₃, La₂O₃, and Gd₂O₃ is in a range of 1 mol % to 80 mol %.

### Aspect 6

The glass substrate according to any one of Aspects 1 to 5, wherein the glass substrate has a specific modulus in a range of 8 MNm/kg to 35 MNm/kg.

### Aspect 7

The glass substrate according to any one of Aspects 1 to 6, wherein the glass substrate has a thickness between 0.1 mm and 1.0 mm.

### Aspect 8

The glass substrate according to any one of Aspects 1 to 7, wherein the first main surface has a surface roughness (Ra) of 10 nm or less.

### Aspect 9

The glass substrate according to any one of Aspects 1 to 8, wherein the glass substrate has a TTV of 10 μm or less.

### Aspect 10

The glass substrate according to any one of Aspects 1 to 9, wherein the glass substrate has a bow of 100 μm or less.

### Aspect 11

The glass substrate according to any one of Aspects 1 to 10, wherein the glass substrate has a warp of 100 μm or less, as determined from a root mean square plane.

### Aspect 12

The glass substrate according to any one of Aspects 1 to 11, wherein the glass substrate is substantially free of arsenic, lead, and antimony.

### Aspect 13

The glass substrate according to any one of Aspects 1 to 12, wherein a total amount of iron, chromium, and nickel is less than 8 ppm by mass.

What is claimed is:

1. A glass substrate having a circular shape, comprising a first main surface and a second main surface opposite each other, an edge portion between the first main surface and the second main surface, and a notch at a part of the edge portion, wherein
a specific gravity of the glass substrate is 3.00 or more;
a radius r of the glass substrate is 75 mm or more;
a refractive index n_{d} of the glass substrate is 1.800 or more;
a ratio (Tf/Tg) of a fictive temperature Tf (° C.) of the glass substrate to a glass transition temperature Tg (° C.) of the glass substrate is 1.00 or more;
in a relationship of an internal transmittance of the glass substrate to a wavelength, when converted for a thickness of 10 mm, with λ₇₀ being a shortest wavelength at which the internal transmittance becomes 70%, λ₇₀ is 440 nm or less; and
a ratio (g/r) of a deviation g (mm), of a center of mass (G) of the glass substrate with respect to a center (P) of the glass substrate, to the radius r, in a top view, is in a range of 0.05% to 1.2%.

2. The glass substrate according to claim 1, wherein
in a side view of the glass substrate, when a bisector passing through a center of a thickness t of the glass substrate is drawn, the edge portion has, above the bisector, a profile including a side surface region and a first chamfered surface,
in a top view of the glass substrate, when a direction along the first main surface and extending perpendicularly to the edge portion of the glass substrate is defined as an X axis, a thickness direction of the glass substrate is defined as a Y axis, a boundary between the side surface region and the first chamfered surface is defined as an origin O of the X axis and the Y axis, a boundary between the first chamfered surface and the first main surface is defined as an intersection S, and a Y-axis value of the intersection S is defined as C (μm), (t/5)≤C≤(t/3),
the first chamfered surface is included in a region Q surrounded by a first straight line connecting the origin 0 and an intersection S′, a line of y=C, and a second straight line connecting the origin O and the intersection S,
the first straight line is represented by Expression (1),
Expression (1) is: y=(C/20)·x,
the second straight line is represented by Expression (2),
Expression (2) is: y=(C/458)·x,
the intersection S′ is an intersection of the first straight line and the line of y=C, and coordinates of the intersection S′ are represented by (X1, C), where 5<X1<50,
the intersection S is an intersection of the second straight line and the line of y=C, and coordinates of the intersection S are represented by (X2, C), where 350<X2<500, and
the first chamfered surface has a profile in which the Y-axis value increases monotonically from the origin O toward the intersection S, within the region Q.

3. The glass substrate according to claim 1, wherein the notch has an opening angle A in a range of 60° to 120°, and a notch tip radius R in a range of 0.7 mm to 3.0 mm.

4. The glass substrate according to claim 1, wherein the glass substrate includes at least one selected from a group consisting of TiO₂, Nb₂O₅, Bi₂O₃, La₂O₃, and Gd₂O₃.

5. The glass substrate according to claim 4, wherein a total amount of TiO₂, Nb₂O₅, Bi₂O₃, La₂O₃, and Gd₂O₃ is in a range of 1 mol % to 80 mol %.

6. The glass substrate according to claim 1, wherein the glass substrate has a specific modulus in a range of 8 MNm/kg to 35 MNm/kg.

7. The glass substrate according to claim 1, wherein the glass substrate has a thickness between 0.1 mm and 1.0 mm.

8. The glass substrate according to claim 1, wherein the first main surface has a surface roughness (Ra) of 10 nm or less.

9. The glass substrate according to claim 1, wherein the glass substrate has a TTV of 10 μm or less.

10. The glass substrate according to claim 1, wherein the glass substrate has a bow of 100 μm or less.

11. The glass substrate according to claim 1, wherein the glass substrate has a warp of 100 μm or less, as determined from a root mean square plane.

12. The glass substrate according to claim 1, wherein the glass substrate is substantially free of arsenic, lead, and antimony.

13. The glass substrate according to claim 1, wherein a total amount of iron, chromium, and nickel is less than 8 ppm by mass.
